(19) United States
(12) Patent Application Publication
(10) Pub. No.: US 2003/0002839 A1
(43) Pub. Date: Jan. 2, 2003

(54) Mounts and alignment techniques for coupling optics, and optical waveguide amplifier applications thereof

(75) Inventors: Lawrence P. Clow JR., Waterford, NY (US); Gary O. Jameson, Saratoga Springs, NY (US); Brian L. Lawrence, Clifton Park, NY (US); Thomas P. Maney, Albany, NY (US); Mark C. Mendrick, Albany, NY (US)

Correspondence Address: HESLIN ROTHENBERG FARLEY & MESITI PC, 5 COLUMBIA CIRCLE, ALBANY, NY, 12203, US

(73) Assignee: Molecular OptoElectronics Corporation, Watervliet, NY

(21) Appl. No.: 09/894,072

(22) Filed: Jun. 28, 2001

(51) Int. Cl. G02B 6/00

(52) U.S. Cl. 385/136

(57) ABSTRACT

A mount apparatus, and methods for forming and using the same, are disclosed for at least one coupling optic requiring alignment along an optical transmission axis. A flanged optical assembly tube is provided, within which the coupling optic is placed along an optical transmission axis, the tube having a flange projecting outwardly from its surface. A mount for supporting the tube is provided, having a base section and an upright section perpendicular to the base. The upright section of the mount includes a vertical surface against which at least one surface of the flange of the tube is affixed. Structural and corrective laser welding techniques are disclosed for permanently mounting and aligning the mount apparatus in an optical component package, aligned with other devices. One such optical component disclosed is an optical waveguide amplifier, having a channel waveguide to and from which aligned optical signals are transmitted.

### CROSS-REFERENCE TO RELATED PATENTS/APPLICATIONS

This Application relates to the following commonly assigned, previously filed, co-pending U.S. Patent Applications:

U.S. patent application Ser. No. 09/121,454, filed Jul. 23, 1998 and entitled “Optical Waveguide With Dissimilar Core and Cladding Materials, and Light Emitting Device Employing the Same” now U.S. Pat. No. 6,141,475;

U.S. patent application Ser. No. 09/121,455, filed Jul. 23, 1998 and entitled “Method for Fabricating an Optical Waveguide” now U.S. Pat. No. ______;

U.S. patent application Ser. No. 09/159,012, filed Sep. 23, 1998 and entitled “Optical Channel Waveguide Amplifier” now U.S. Pat. No. 6,236,793;

U.S. patent application Ser. No. 09/316,102, filed May 24, 1999 and entitled “Compact Optical Amplifier With Integrated Optical Waveguide and Pump Source” now U.S. Pat. No. 6,208,456; and

U.S. patent application Ser. No. 09/518,390, filed Mar. 3, 2000 and entitled “Compact Optical Amplifier with Integrated Optical Waveguide, Pump Source, and Performance Enhancing Optical Components” now U.S. Pat. No. ______.

Each of these previously filed U.S. Patent Applications is hereby incorporated by reference herein in its entirety.

### TECHNICAL FIELD

The present invention relates to mounting and alignment techniques for free-space coupling optics, and applications thereof in optical amplifiers requiring free space coupling to or from fiber optic signal and pump sources.

### BACKGROUND OF THE INVENTION

The field of fiber optic communication continues to draw much attention, with optical transmission over fiber optic links offering much greater and reliable bandwidth than conventional lower frequency (i.e., RF) approaches. In addition to established “long-haul” fiber links, interest continues to grow in the rapid spread of fiber links into urban, “metro” areas currently constrained by the much lower bandwidths of twisted pair and coaxial cable, and in other parts of the world lacking any installed communication media.

Among many other technologies, optical amplification plays a key role in fiber optic transmission. Optical amplifiers enable optical transmission over longer distances in long-haul networks, and through the geographically and structurally diverse network “terrain” in densely populated metro areas. Before the advent of optical amplifiers, fiber links required expensive and cumbersome electrical regeneration at lossy points. Optical amplifiers eliminate this costly regeneration by amplifying the signal directly in the optical spectral regions (e.g., 1550 nm), without electrical regeneration.

In fact, optical amplifiers have enabled the recent introduction of dense wavelength division multiplexing (DWDM) which involves independent and simultaneous transmission of different data streams (e.g., 10 GB/sec each) on different respective wavelengths across the band (e.g., the “C” band from about 1530-1562 nm). Electronic detectors used in regeneration are incapable of discriminating between different wavelengths, therefore, DWDM systems require an independent repeater for each wavelength in the system, as well as the necessary filtering components to isolate each of the wavelengths into their respective repeaters. DWDM systems with regeneration are thus prohibitively expensive.

The advent of optical amplification fundamentally changed the potential topologies of DWDM networks. Because the optical amplifier is capable of amplifying multiple wavelengths independently in a single unit, a DWDM system can use a single optical amplifier for all channels, thus eliminating regeneration entirely.

System manufacturers are desirous of devices in increasingly smaller and more compact packages, while at the same time integrating multiple functions into a single device. In sharp contrast to the ever-shrinking size of many optical network components, the well-known erbium doped fiber amplifier (“EDFA”) faces certain limits because of the fixed value of the minimum bend radius of the fiber. Bend losses are proportional to the bend radius, and hence the radius must be kept large. A nominal radius for such fiber is about 3.75 cm, resulting in a coil diameter of about 7.5 cm (about 3 inches) which in turn results in an minimum package planar dimension of at least 3½×3½ inches. Consequently, though many components such as the isolators, 980/1550 nm multiplexers, and monitor taps and photodiodes can be integrated into the package, the footprint remains constrained by the minimum diameter of the erbium-doped fiber coil. Nominal package dimensions are now about 6×6 inches. Moreover, EDFAs have certain commercial disadvantages, such as the high cost of the doped fiber and the single mode pump diodes.

Semiconductor optical amplifiers (SOAs) are also available, and rely on electrical (rather than optical) pump sources for amplification. However, their performance characteristics are known to be deficient in many areas, compared to EDFAs.

As systems continue to grow and expand into the “metro” domain, system designers find themselves in need of new devices, amplifiers in particular, that are smaller and less expensive than their current counterparts. A compact, low cost optical amplifier is therefore required. In the commonly-assigned, above-incorporated U.S. Patent Applications, a waveguide amplifier is disclosed which addresses some of these size and cost concerns. As shown in the opening figures herein (discussed in greater detail below) packaged amplifier 100 includes an easily fabricated waveguide chip 110 with an on-board signal/pump multiplexer and gain medium. Signal input coupling optics 120 and output coupling optics 130 are provided to focus the optical signal into and out of the waveguide chip from input fiber 122 and output fiber 132, respectively; and pump coupling optics 150 are provided to focus the optical pump source into the chip. In one embodiment, the pump source is multimode, and the signal is single mode. Multi-mode pumps increase the absorption in the gain medium, and are available in greater quantities at cheaper prices than their single mode counterparts.

The free space optical coupling approach allows greater flexibility in the choice of waveguide chip architecture, but also leads to alignment challenges. The optical signal and pump must be focused into the chip with an accuracy of a few microns, since the gain medium (i.e., the core 212) has a cross section on the order of 10-15 mm on a side; a typical fiber optic core diameter (SMF-28) is on the order of 8 mm; and the laser diode (pump) aperture is on the order of 1×100 mm. Thus any mounting technique used to affix the various coupling optics into a package must be very accurate, and the mounts must maintain their position without significant movement during fabrication, and over the useful life of the amplifier.

What is needed, therefore, are alignment and mounting techniques for coupling optics used to free-space couple optical signals to and from fiber optics and pump sources; with an emphasis on their use in waveguide amplifiers.

### SUMMARY OF THE INVENTION

The shortcomings of the prior approaches are overcome, and additional advantages are provided, by the present invention which in one aspect is a mount apparatus, and methods for forming and using the same, for at least one coupling optic requiring alignment along an optical transmission axis. A flanged optical assembly tube is provided, within which the coupling optic is placed along an optical transmission axis thereof, the tube having a flange projecting outwardly from its surface. A mount for supporting the tube is provided, having a base section and an upright section perpendicular thereto. The upright section of the mount includes a vertical surface against which at least one surface of the flange of the tube is affixed.

The flange projects outwardly from the surface of the tube at a 90 degree angle relative to the optical transmission axis of the tube, and the upright section of the mount includes a slot into which the tube is affixed. The flange has at least one outer edge surface coplanar with at least one outer edge surface of the mount.

The flange and the upright section may be affixed with a series of laser welds along the junction of the coplanar outer edge surfaces; and the flange and the upright section may have equivalent widths such that both outer edge surfaces of each are respectively coplanar with a respective outer edge surface of the other, and the flange and the upright section are affixed with respective series of laser welds along each junction of the coplanar outer edge surfaces.

The mount apparatus is especially useful in an optical component package requiring the coupling optic to be aligned along the transmission axis of the tube, in which case the mount apparatus is affixed in said package to effect said alignment. The mount apparatus may be affixed in the package with a series of structural and corrective laser welds along at least one lower edge of the base section of the mount; and the flanged optical assembly may have at least one thinned portion with a series of corrective laser welds thereon.

The mount apparatus may have particular applicability in an optical amplifier package, having a channel waveguide chip including a gain medium for amplifying an input signal and producing an output signal, and a pump source, wherein the mount apparatus is affixed in the package such that the coupling optic therein facilitates coupling of at least one of the input signal, output signal, or pump, to or from the waveguide chip.

The channel waveguide chip may include an amplifying core having an input end for receiving the input signal and the pump, and an output end for producing an amplified, output signal; and a region proximate said input end of said amplifying core in which the input optical signal and the optical pump signal are combined. In one embodiment, the region comprises a surface through which the pump is received, and wherein the pump and the input signal are together combined into the core at said surface. In this embodiment, the surface of the channel waveguide chip is arranged at an approximately 45 degree angle with the core thereof, the pump source transmits the pump at approximately a 90 degree angle with the core, and the channel waveguide chip may include a reflective coating applied over the surface to reflect and thereby combine the pump into the core with the input signal.

The materials comprising the core and a cladding of the waveguide may be structurally and/or chemically distinct having been separately fabricated as physically different materials and brought together during waveguide assembly.

In one amplifier embodiment, the input signal is single mode and the pump is multi-mode, and the only optical ports to or from the package are optical signal input and output ports, and the package has at least one planar dimension less than about three inches.

The flanged optical assembly tubes and L-mounts, and their mounting and alignment techniques, are especially suited for this type of amplifier, though they are also applicable in other optical applications wherein the optics in an assembly tube require mounting in a package, and permanent alignment with other optical components along a common optical transmission axis. These techniques (the mutually perpendicular portions of the mount, and the flat mating surfaces) ensure proper alignment of the mount when affixed in a package.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following detailed description of the preferred embodiment(s) and the accompanying drawings in which:

FIG. 1a is a top plan view of the components of an optical amplifier in accordance with the present invention;

FIG. 1b is a perspective view of the components of FIG. 1a;

FIG. 2a is a perspective view of a channel waveguide amplification chip employed in the amplifier of FIGS. 1a-b;

FIG. 2b is a front view of the channel waveguide chip of FIG. 2a;

FIG. 3 is a packaged embodiment of the optical amplifier in accordance with the present invention;

FIG. 4a is a perspective view of a flanged optical assembly tube mounted on an L-mount, with associated laser weld patterns, in accordance with the present invention;

FIG. 4b shows the components of FIG. 4a from a different angle;

FIG. 5 is a cross-sectional view of a flanged optical assembly tube showing a thinned portion for corrective laser hammering; and

FIGS. 6a-b are perspective views of the assembly tube/L-mount combination associated with the pump signal source, in accordance with the present invention.

### DETAILED DESCRIPTION OF THE PREFERRED EMBODIMENT(S)

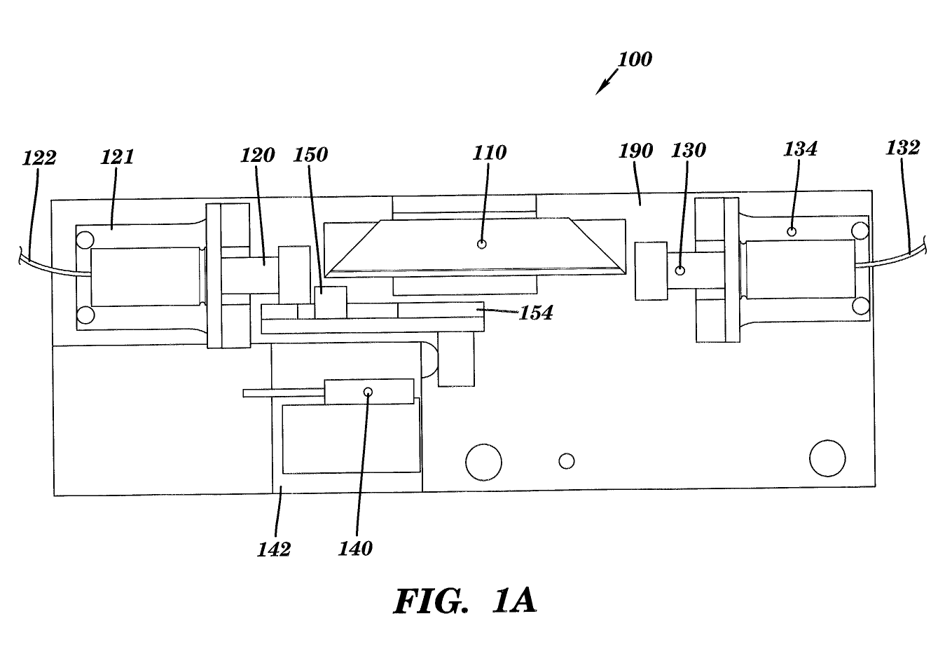

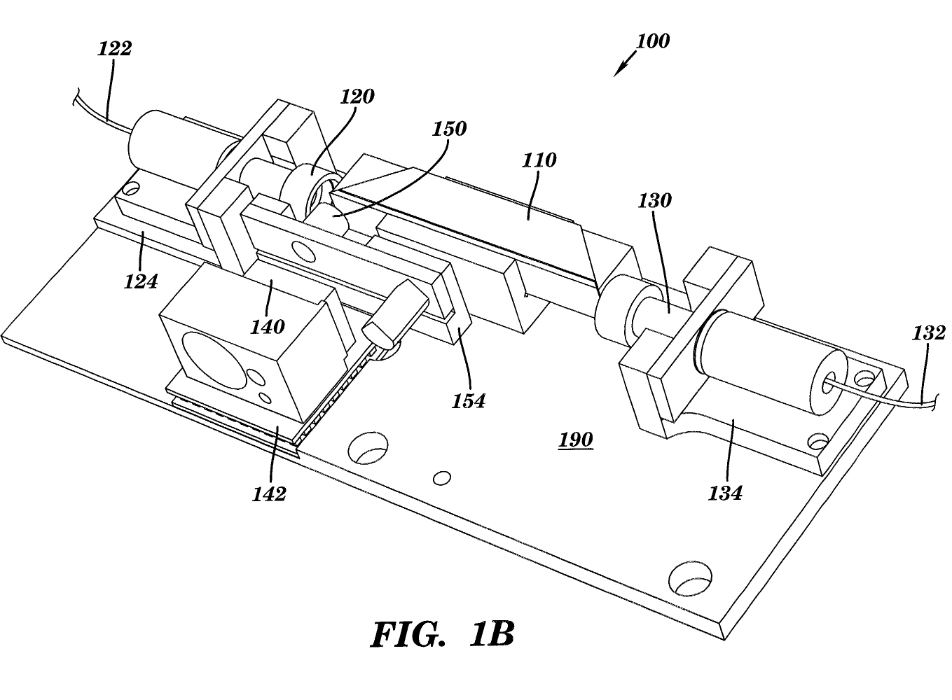

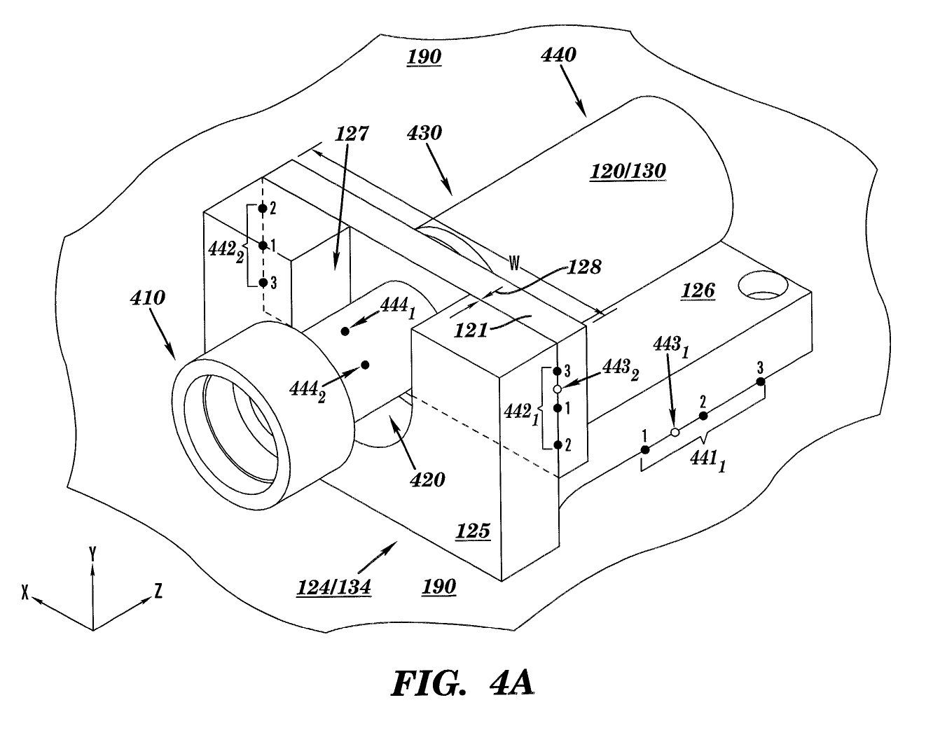

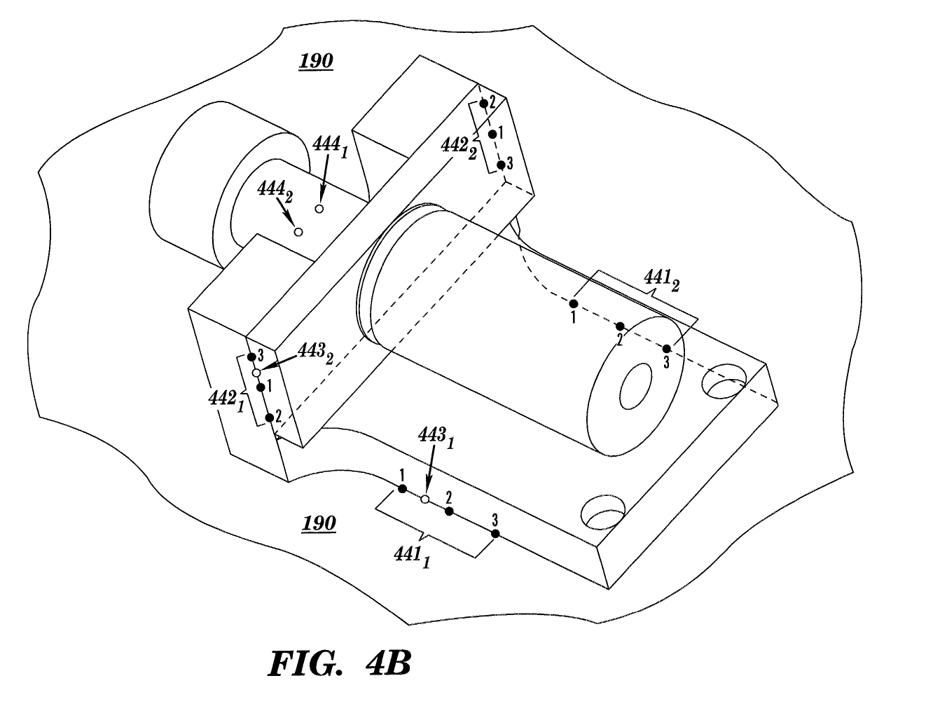

With reference to FIGS. 1a-b, compact waveguide amplifier 100 in accordance with the present invention includes a channel waveguide amplifier chip 110 as the gain medium with on-board signal/pump multiplexing, signal input coupling optics in a flanged optical assembly tube 120 (to couple the optical input signal from input fiber 122), signal output coupling optics in another flanged optical assembly tube 130 (to couple the optical output signal to output fiber 132), a pump laser diode 140, and pump coupling optics in another flanged optical assembly tube 150 (to couple the optical pump signal between pump laser 140 and chip 110). These components may be aligned on alignment bench 190 using mounts 124, 134 and 154, respectively (the details of which are discussed further below with reference to FIGS. 4-6). In accordance with the above-incorporated applications entitled “Compact Optical Amplifier With Integrated Optical Waveguide and Pump Source” and “Compact Optical Amplifier with Integrated Optical Waveguide, Pump Source, and Performance Enhancing Optical Components,” optional components such as planar lightwave circuit and its associated coupling optics can also be integrated into any of the optical paths of amplifier 100, but are omitted from these figures for clarity.

The compact size of the amplifier results from the small waveguide chip 110, coupled with the ability to use an integrated diode pump 140, discussed further below.

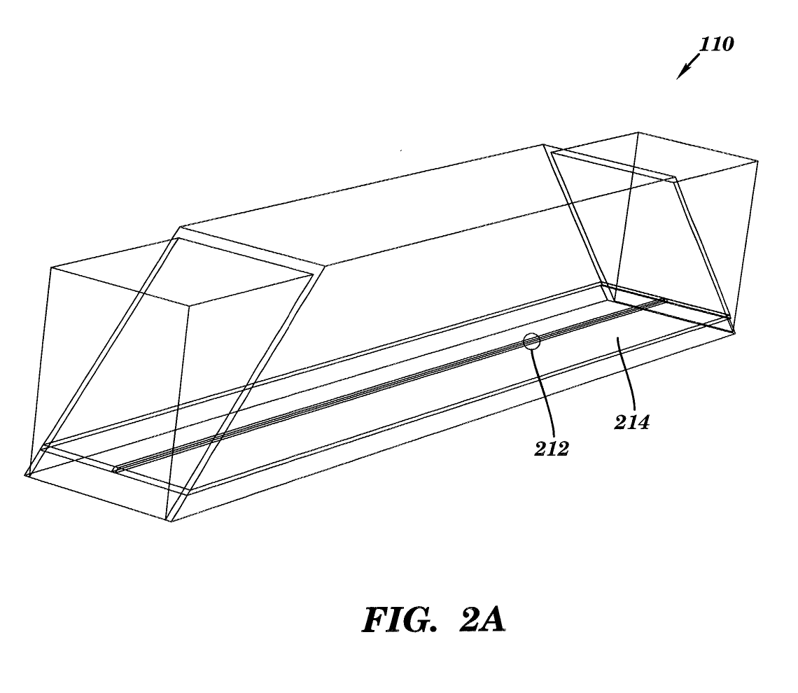

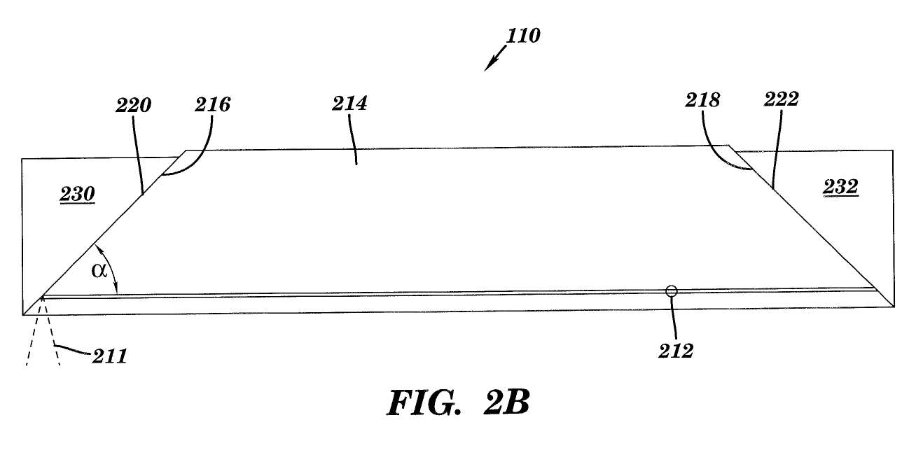

Exemplary channel waveguide chip 110, shown in detail in FIGS. 2a-b, may be of the type disclosed in the above-incorporated applications entitled “Optical Waveguide With Dissimilar Core and Cladding Materials, and Light Emitting Device Employing the Same” and “Optical Channel Waveguide Amplifier.” The waveguide may be fabricated using the procedures disclosed in the above-incorporated application entitled “Method for Fabricating an Optical Waveguide”.

This optical waveguide 110 includes a core 212 of active material surrounded by a cladding 214 comprising, for example, a dissimilar material than the core. As used herein, the phrase “dissimilar material” means that the material comprising the cladding and the material comprising the core are structurally and/or chemically distinct having been separately fabricated as physically different materials and brought together during the assembly process for the optical waveguide 110.

Briefly summarized, in one embodiment fabrication of optical waveguide 110 is a multi-step process using precision lapping and polishing techniques to mechanically thin the selected optical material (i.e., core) to the desired thickness in both the lateral and vertical directions. Optical adhesives are used to bond the channel waveguide to the surrounding support/cladding media. The fabrication process may include preparing a flat, optical surface on both the chosen optical material (i.e., core) and the chosen support substrate (i.e., cladding). Fused silica may be used as a support substrate due to its ease of processing and low refractive index. In the case of very thin adhesive layers (<1 μm), for efficient waveguiding action, the channel must be surrounded by a lower refractive index material. Obviously, the refractive index of the selected optical material (core) determines the index range for the cladding or support regions. Other requirements of the surrounding medium are processing compatibility with the optical material, availability of the material, and adhesive bonding affinity. Fused silica meets these requirements, although a range of optical glasses are also ideal.

To effect the requisite optical gain, the waveguide chip 110 may be composed of a linear core 212 doped with active ions. The compact nature of the waveguide is enabled by the use of high-gain materials. Of particular applicability is the family of Erbium/Ytterbium (Er/Yb) co-doped phosphate glasses which have nearly 100 times the number density of atoms, do not suffer quenching effects, and have twice the emission cross-section relative to their silica counterparts typically used in EDFAs. The core 212 may be nominally square in cross-section and of size from 10 mm to 30 mm on a side. The surrounding cladding 214 may be an undoped material of lower refractive index, effecting guiding of the now multiplexed input and pump signals. To multiplex the input and pump signals, the input end of the waveguide chip may be polished at an exemplary angle (α) of 45 degrees with respect to the waveguide axis. The input, angle-polished end 216 is then coated 220 to transmit the input optical signal into the core, but reflect the applied pump signal 211 into the core, and overlaid with a prism 230 matched in index to the core (and bonded to the waveguide with, e.g., an ultraviolet (UV)-cured optical adhesive) for directing the input optical signal colinearly into the core.

The opposing end of the waveguide may be prepared in one of two ways. The first design (not shown) utilizes a perpendicular end-face with an anti-reflection (AR) coating to minimize back-reflections. If, however, the AR coating is insufficient, the second design option (shown) involves polishing end 218 at an angle, which is then anti-reflectively coated 222 and overlaid with a prism 232 matched in index to the core (and bonded to the waveguide with, e.g., an ultraviolet (UV)-cured optical adhesive) for directing the input optical signal colinearly from the core, for the purpose of further mitigating reflections.

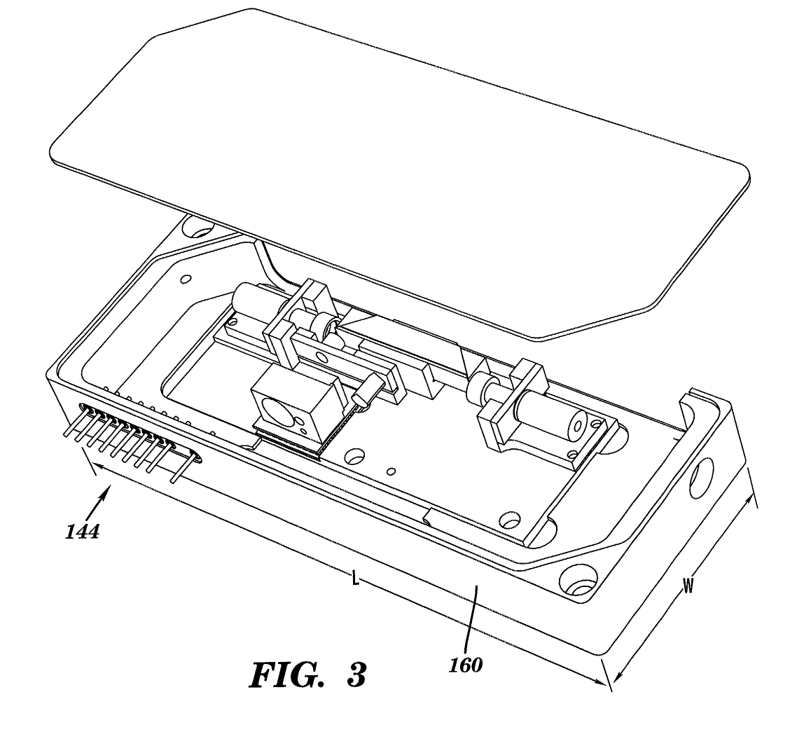

With reference to the exploded, packaged view of the amplifier of FIG. 3, the channel waveguide chip in one embodiment is about 10-30 mm in length (L), and the overall planar dimensions of the amplifier package 160 (i.e., the length “L” and width “W”), can therefore be about 2½×1½ inches. (The package thickness is about ¾ inch.) This smaller, overall planar dimension stands in contrast to that of a functionally equivalent EDFA amplifier of 6×6 inches, at the 1530-1565 nm bandwidth of interest, and in fact is even better than the known, minimal planar dimensions of EDFAs discussed above of 3×3 inches, based on the minimum bend radius. The present invention therefore provides at least one (and in fact both) planar dimensions of less than about 3 inches. Waveguide chip 110 of amplifier 100 provides high gain in a relatively short device (when compared to the several meters of erbium-doped fiber typical in EDFAs), and therefore results in a smaller size of the amplifier housings.

Waveguide 110 requires a pump source to provide the optical pump signal waveguide gain. To couple the signal 211 from the pump laser diode into the waveguide 110, lenses in assembly tube 150 are used to focus the power into the waveguide off of the 45-degree coated end-face of the waveguide. The pump source may therefore be arranged to transmit the optical pump signal at an angle of 90 degrees relative to the longitudinal axis of the waveguide. Notably, the optical pump signal is generated internal to the amplifier housing, and no additional optical input ports are required for the pump signal. This feature adds to the cost and space savings provided by the amplifier disclosed herein. With reference to FIGS. 1a-b, exemplary pump source 140 disclosed herein is a single or multi-mode laser diode on a submount and maintained at constant temperature with a thermo-electric cooler (TEC) 142. Power is provided to both the laser diode and the TEC through external package pins 144 (shown in FIG. 3). Additional pins may also be included to incorporate a monitor photodiode to monitor pump laser power, a thermistor to monitor pump laser temperature, and gain monitoring sensors (not shown).

Because free-space optical coupling is employed in this amplifier to focus the transmissions from the signal and pump sources into the narrow core of the waveguide chip, alignment and mounting techniques are necessary which allow precise alignment within the optical paths in the single or sub-micron ranges. These techniques must also prevent drift of those components out of alignment, either during the attachment process itself, or throughout the life of the product. In accordance with the present invention, improved mounts and mounting techniques are disclosed which provide greater alignment accuracy, and reliability, than those of the prior art.

With reference to the perspective views of FIGS. 4a-b, the improved mounts and mounting techniques will be described. For the purposes of this discussion, the input 120 and output 130 assembly tubes, and their mounts 124 and 134, are assumed similar and are thus discussed with reference to the same figures. Any potential differences will be pointed out where needed.

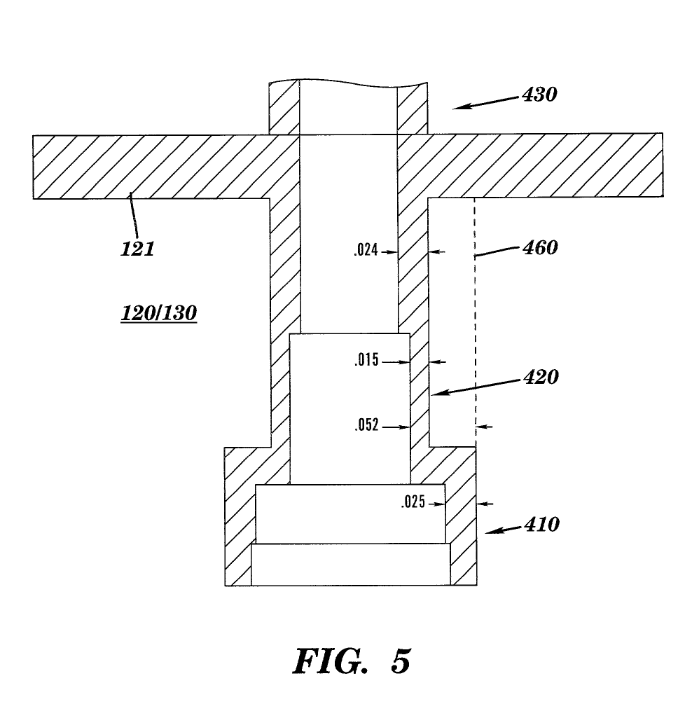

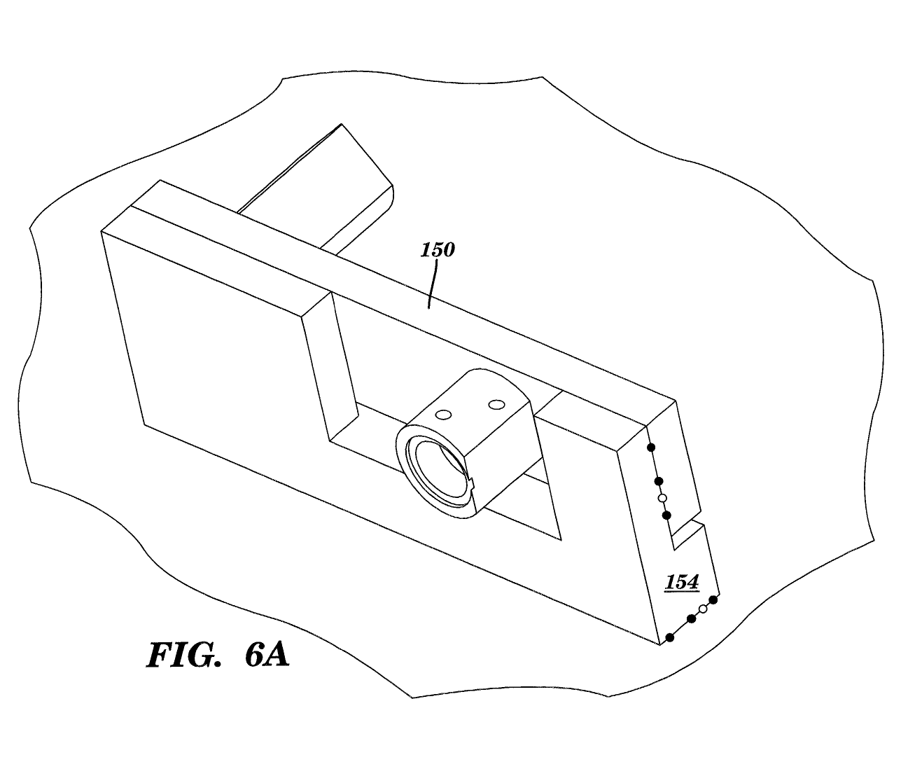

The assembly tube 120/130 encloses optics necessary for the optical focusing into and out of the fibers and waveguide as discussed above, and comprises about 4 exemplary sections. (The term “tube” is used broadly herein to connote any type of structure, whether cylindrical or not, used to support optical component(s) facilitating transmission along the transmission axis thereof; similarly, the term “coupling optic” is also used broadly herein to connote any type of optical device used to facilitate transmission along an optical path, with or without imparting changes to the signal.) Section 410, with a relatively wide diameter, is designed to hold an asphere lens for the final focusing into/out of the waveguide. Section 420, having a reduced diameter and thickness (discussed below), holds a portion of an isolator (optional in the output assembly). Section 420 terminates at perpendicular flange 121. Preferably, as discussed below with reference to FIG. 5, sections 410, 420 and flange 121 are machined from a single sample of stainless steel (e.g., 304L), since established machining techniques can ensure a perpendicular relationship to the requisite tolerances. Section 430 (preferably a separate section of the assembly tube flush mounted against flange 121) may also hold a portion of an optical isolator. Section 440 holds a collimating lens for interface to the input/output fibers (not shown for clarity).

The mount 124/134 is L-shaped and includes an upright section 125 and a perpendicular, base section 126, preferably machined from a common INVAR sample. A U-shaped slot 127 is machined into the upright section 125 to accommodate the assembly tube 120/130.

In accordance with the present invention, section 126 of mount 124/134 is mounted to the underlying alignment bench 190, and tube 124/134 is mounted to the upright section 125 of the mount. In the preferred embodiment, mounting is effected using a series of laser welding points 441-444. Laser welding is preferable to other bonding techniques such as epoxy, because of its durability and long-term reliability.

The unitary, machined nature of L-mount 124/134; and that of flange 121 relative to sections 410, 420 of the assembly tube, ensures very precise perpendicularity and therefore linear alignment between the tube and waveguide core, along the optical transmission path. This alignment is improved by ensuring that the mating surfaces (designated together as junction 128) are machined to a “16” finish. This combination of smooth, vertical mating surfaces, machined to be precisely perpendicular to the tube axis and base respectively, ensures alignment of the optical axis with the waveguide core, especially along the X-Y axes shown. Moreover, the outer, vertical surfaces of the flange 121 and upright portion 125 are machined to ensure co-planar relationship by ensuring identical dimensions “W,” to thereby accommodate laser weld series 442₁ and 442₂.

These components are initially welded onto bench 190 according to two “structural” welding phases as follows:

During a first welding phase, opposing laser weld series 441₁ and 441₂ are performed simultaneously in the front-to-back, 1-2-3 sequence shown, to mount the L-mount 124/134 to the underlying optical bench 190. This fixes motion of the mount in the Z axis direction.

During a second welding phase, the assembly tube is positioned with its flange against and aligned to the upright section 121 of the mount, and opposing weld series 442₁ and 442₂ are performed simultaneously, in the respective 1-2-3 sequences shown, to affix the assembly tube to the mount along the outer, coplanar edge surfaces. The corners should therefore be “sharp” at these edges to ensure a smooth junction which better accommodates these welds. These “edge” welds are better than through “lap” welds, as they ensure better alignment. Notably, the sequence of the second and third welds is switched to offset any adverse impact of post-weld shifting along the X-Y axes.

These first two series of welds (441 and 442) are “structural” inasmuch as they affix the mount to the alignment bench, and then the assembly tube to the mount. During these structural welds, the mount and assembly tube are held in place with movable gripping tools, and can be initially aligned to the previously mounted waveguide core by high-precision visual or automated sensing apparatus. Preferably, however, an input optical signal source and output monitor are used to measure alignment along the optical path. A “best case” transmission spectra (i.e., gain) is obtained while the components are held in place accurately with external tooling, and this gain is ideally maintained as the welds are made and the tooling removed. However, due to post-weld shift phenomena, wherein material contraction occurs while the welds cool, mis-alignment may result.

To correct for post-weld shift, at least two more “corrective” weld phases are employed subsequent to the first and second “structural” phases above.

During a third welding phase, corrective welds such as 443₁ and 443₂ are made. These welds use the above-described phenomena of post-weld shift to re-align the areas which may have previously shifted. The placement of these welds is chosen to correctively re-shift the components opposite to the directions in which they moved during the structural weld phase. The location(s) of the welds are chosen based on the desired movement direction and distance, and knowing that welds at joints usually cause a pulling motion in the direction of the larger/fixed mass. In the configuration described here, an adjustment of 2-3 dB in optical signal gain can be expected during this corrective phase.

During a fourth welding phase, corrective welds such as 444₁ and 444₂ are made, on the surface of a thinned portion (section 420) of the assembly tube itself. In accordance with the present invention and as shown in FIG. 5 (dimensions in inches), the walls of this section of the tube are adequately thinned to a thickness of about 15 mils, in section 420 of the tube. At this thickness (using a Unitek Miyachi LW51 laser welding system) the post-weld cooling process can be expected to contract local material, and therefore “pull” other adjacent portions of the tube toward the weld. This has the effect of bending or pivoting that portion of the tube in a desired direction, i.e., toward the waveguide core, so that the asphere lense mounted in section 410 of assembly tube 120/130 is further aligned with the waveguide core. This can provide finer gain adjustments, in the range of 0.1 Db.

With further reference to the cross-sectional view of FIG. 5, the “thinned” section 420 is shown in greater detail. Dashed line 460 represents the outer diameter of the tube had this extra thinning process not been employed, and would have resulted in a 52 mil thickness in this section. This outer diameter would have corresponded to the outer diameter of section 410, where the asphere lens is located, for machining ease. An extra machining step is therefore employed to provided the thinned section. (The inner diameters of the tube are determined as a function of the internal optics, omitted here for clarity.)

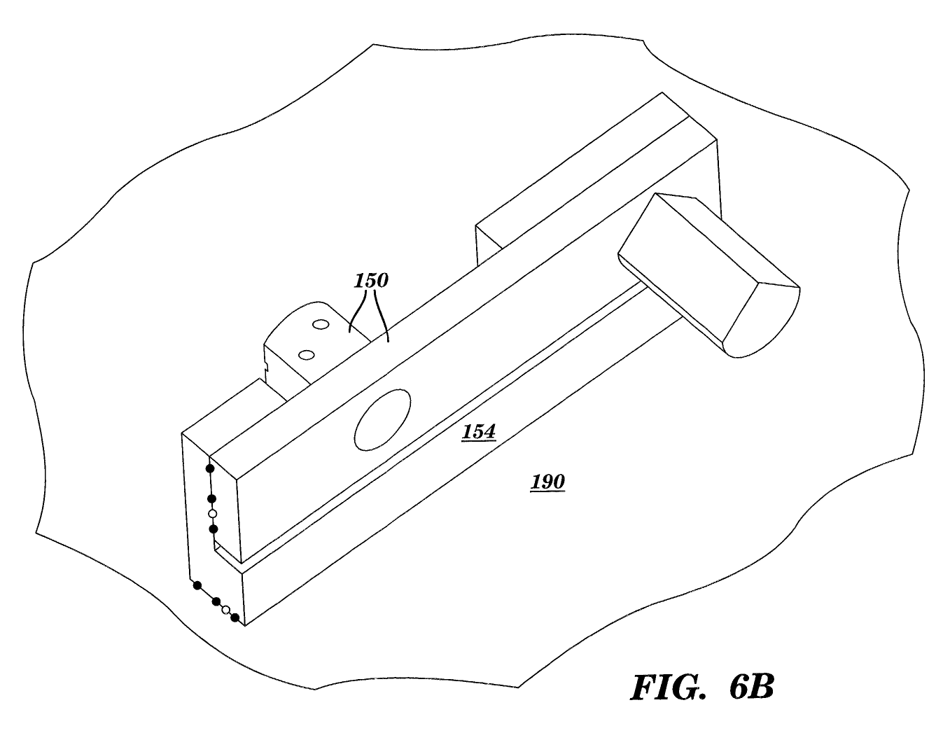

FIGS. 6a-b show views of the assembly tube 150 and L-mount 154 combination used to focus the pump signal into the waveguide. While the dimensions of this combination are somewhat different than the dimensions of the FIG. 4a-b combination, the same general structural and process techniques discussed above apply, i.e., the use of an L-shaped mount, the flanged assembly tube designed to mate with the mount, and similar structural and corrective laser weld patterns. Also, only an asphere lens is provided in this assembly tube; as a fast axis collimating (FAC) can be placed on the diode assembly itself.

The amplifier disclosed herein facilitates integration of additional components. An optional planar lightwave circuit (PLC) may be inserted into the optical path, for example, a silica waveguide splitter or an arrayed waveguide grating (AWG) multiplexer. This device, because of its performance in a filter capacity, has potentially high insertion loss. However, when integrated with the compact, low-cost amplifier discussed above in a small package, the intrinsic losses are offset to create so-called “lossless” versions. Many benefits result from a small, inexpensive amplifier integrated with one, or even several, additional optoelectronic components, such as a PLC.

Because the waveguide is coupled to fibers, other fiber coupling devices can be placed in the path to enhance performance. Improved coupling optics (input and/or output) include, for example, a thin-film gain-flattening filter. This filter can be obtained with a gain profile inverse to that of the amplifier itself. The filter results in a flat gain curve. Gain-flattening is desirable, especially between the operating bandwidth of about 1530-1560 nm.

An optical tap (e.g., 1% mirror) is also possible, having an output directed to a photodetector. These optional components could be used for monitoring the optical signal as it passes through the amplifier.

These performance enhancing optical components could be placed in the input optics, output optics, or both, and these terms are used broadly herein to connote any hardware which can be fairly characterized as carrying signals to or from the waveguide.

In current implementations, the small signal gain of the amplifier is about 10 dB; the noise figure at 1550 nm, −30 dBm is <5 dB; the 5 dB gain bandwidth (without flattening) spans from about 1525 to 1560 nm; the maximum saturated output power is >13 dBm; and the output power at the 3 dB gain compression (1550 nm) is >10 dBm. Offering more than 10 dB of gain and saturated powers above 13 dBm, this amplifier is suitable for overcoming losses associated with couplers, WDMs, switches and other passive optical components necessary in optical networking systems. Its applications include metropolitan networks; lossless branching; testbeds; instrumentation; optical add-drop multiplexers; and optical switch arrays.

The amplifier discussed herein, based on a channel waveguide chip, provides compact, low cost optical solutions for use in fiber optic systems. Its primary application is optical amplification in communication systems where space is at a premium, and smaller devices are required. In addition, these amplifiers are ideal for use in systems where the design requires large numbers of low-cost devices to achieve the desired performance. Finally, because of their compact nature, the amplifiers can be integrated with other devices such as splitters or multiplexers and de-multiplexers. When adding additional components into the package, the insertion loss associated with the components can be offset by the optical amplification, allowing for the development of “lossless” versions of these very same optical components.

The flanged optical assembly tubes and L-mounts, and their mounting and alignment techniques, are especially suited for this type of amplifier, though they are also applicable in other optical applications wherein the optics in an assembly tube require mounting in a package, and permanent alignment with other optical components along a common optical transmission axis. These techniques (the mutually perpendicular portions of the mount, and the flat mating surfaces) ensure proper alignment of the mount when affixed in a package.

While the invention has been particularly shown and described with reference to preferred embodiment(s) thereof, it will be understood by those skilled in the art that various changes in form and details may be made therein without departing from the spirit and scope of the invention.

What is claimed is:

1. A mount apparatus for at least one coupling optic requiring alignment along an optical transmission axis, comprising:
a flanged optical assembly tube within which the coupling optic is placed along an optical transmission axis thereof, the tube having a flange projecting outwardly from its surface; and
a mount for supporting the tube, the mount having a base section and an upright section perpendicular thereto;
wherein the upright section of the mount includes a vertical surface against which at least one surface of the flange of the tube is affixed.

2. The mount apparatus of claim 1, wherein the flange projects outwardly from the surface of the tube at a 90 degree angle relative to the optical transmission axis of the tube, and wherein the upright section of the mount includes a slot into which the tube is affixed.

3. The mount apparatus of claim 2, wherein the flange has at least one outer edge surface coplanar with at least one outer edge surface of the mount.

4. The mount apparatus of claim 3, wherein the flange and the upright section are affixed with a series of laser welds along the junction of the coplanar outer edge surfaces.

5. The mount apparatus of claim 3, wherein the flange and the upright section have equivalent widths such that both outer edge surfaces of each are respectively coplanar with a respective outer edge surface of the other.

6. The mount apparatus of claim 5, wherein the flange and the upright section are affixed with respective series of laser welds along each junction of the coplanar outer edge surfaces.

7. The mount apparatus of claim 1, in combination with an optical component package requiring said coupling optic to be aligned along the transmission axis of the tube, the mount apparatus affixed in said package to effect said alignment.

8. The combination of claim 7, wherein the mount apparatus is affixed in the package with a series of structural and corrective laser welds along at least one lower edge of the base section of the mount; and wherein the flanged optical assembly has at least one thinned portion with a series of corrective laser welds thereon.

9. The mount apparatus of claim 1, wherein the flanged optical assembly has at least one thinned portion for facilitating corrective laser welding.

10. The mount apparatus of claim 1, in combination with an optical amplifier package, having a channel waveguide chip including a gain medium for amplifying an input signal and producing an output signal, and a pump source, wherein the mount apparatus is affixed in the package such that the coupling optic therein facilitates coupling of at least one of the input signal, output signal, or pump, to or from the waveguide chip.

11. The combination of claim 10, wherein the channel waveguide chip comprises:
an amplifying core having an input end for receiving the input signal and the pump, and an output end for producing an amplified, output signal; and
a region proximate said input end of said amplifying core in which the input optical signal and the optical pump signal are combined.

12. The combination of claim 11, wherein:
the region comprises a surface through which the pump is received, and wherein the pump and the input signal are together combined into the core at said surface.

13. The combination of claim 12, wherein the surface of the channel waveguide chip is arranged at an approximately 45 degree angle with the core thereof, the pump source transmits the pump at approximately a 90 degree angle with the core, the channel waveguide chip further comprising:
a reflective coating applied over the surface to reflect and thereby combine the pump into the core with the input signal.

14. The combination of claim 10, wherein the materials comprising the core and a cladding of the waveguide are structurally and/or chemically distinct having been separately fabricated as physically different materials and brought together during waveguide assembly.

15. The combination of claim 10, wherein the input signal is single mode and the pump is multi-mode, wherein the only optical ports to or from the package are optical signal input and output ports, and wherein the package has at least one planar dimension less than about three inches.

16. A method for fabricating a mount apparatus for at least one coupling optic requiring alignment along an optical transmission axis, comprising:
providing a flanged optical assembly tube within which the coupling optic is placed along an optical transmission axis thereof, the tube having a flange projecting outwardly from its surface;
providing a mount for supporting the tube, the mount having a base section and an upright section perpendicular thereto; and
affixing at least one surface of the flange of the tube to a vertical surface of the upright section of the mount.

17. The method of claim 16, wherein the flange projects outwardly from the surface of the tube at a 90 degree angle relative to the optical transmission axis of the tube, and wherein the upright section of the mount includes a slot into which the tube is affixed.

18. The method of claim 17, wherein the flange has at least one outer edge surface coplanar with at least one outer edge surface of the mount.

19. The method of claim 18, further comprising affixing the flange and the upright section with a series of laser welds along the junction of the coplanar outer edge surfaces.

20. The method of claim 18, wherein the flange and the upright section have equivalent widths such that both outer edge surfaces of each are respectively coplanar with a respective outer edge surface of the other.

21. The method of claim 20, further comprising affixing the flange and the upright section with respective series of laser welds along each junction of the coplanar outer edge surfaces.

22. The method of claim 16, in combination with a method for fabrication an optical component package requiring said coupling optic to be aligned along the transmission axis of the tube, comprising:
affixing the mount apparatus in said package to effect said alignment.

23. The combination of claim 22, wherein the mount apparatus is affixed in the package with series of structural and corrective laser welds along at least one lower edge of the base section of the mount; and wherein the flanged optical assembly has at least one thinned portion with a series of corrective laser welds thereon.

24. The method of claim 16, wherein the flanged optical assembly has at least one thinned portion for facilitating corrective laser welding.

25. The method of claim 16, in combination with a method for forming an optical amplifier package, having a channel waveguide chip including a gain medium for amplifying an input signal and producing an output signal, and a pump source, comprising:
affixing the mount apparatus in the package such that the coupling optic therein facilitates coupling of at least one of the input signal, output signal, or pump, to or from the waveguide chip.

26. The combination of claim 25, wherein the channel waveguide chip comprises:
an amplifying core having an input end for receiving the input signal and the pump, and an output end for producing an amplified, output signal; and
a region proximate said input end of said amplifying core in which the input optical signal and the optical pump signal are combined.

27. The combination of claim 26, wherein:
the region comprises a surface through which the pump is received, and wherein the pump and the input signal are together combined into the core at said surface.

28. The combination of claim 27, wherein the surface of the channel waveguide chip is arranged at an approximately 45 degree angle with the core thereof, the pump source transmits the pump at approximately a 90 degree angle with the core, the channel waveguide chip further comprising:
a reflective coating applied over the surface to reflect and thereby combine the pump into the core with the input optical signal.

29. The combination of claim 28, wherein the materials comprising the core and a cladding of the waveguide are structurally and/or chemically distinct having been separately fabricated as physically different materials and brought together during waveguide assembly.

30. The combination of claim 25, wherein the input signal is single mode and the pump is multi-mode, wherein the only optical ports to or from the package are optical signal input and output ports, and wherein the package has at least one planar dimension less than about three inches.

31. A method for using a mount apparatus to align a coupling optic therein along an optical transmission axis, comprising:
providing a flanged optical assembly tube within which the coupling optic is placed along an optical transmission axis thereof, the tube having a flange projecting outwardly from its surface;
providing a mount for supporting the tube, the mount having a base section and an upright section perpendicular thereto; and
affixing at least one surface of the flange of the tube to a vertical surface of the upright section of the mount.

32. The method of claim 31, wherein the flange projects outwardly from the surface of the tube at a 90 degree angle relative to the optical transmission axis of the tube, and wherein the upright section of the mount includes a slot into which the tube is affixed.

33. The method of claim 32, wherein the flange has at least one outer edge surface coplanar with at least one outer edge surface of the mount.

34. The method of claim 33, further comprising affixing the flange and the upright section with a series of laser welds along the junction of the coplanar outer edge surfaces.

35. The method of claim 33, wherein the flange and the upright section have equivalent widths such that both outer edge surfaces of each are respectively coplanar with a respective outer edge surface of the other.

36. The method of claim 35, further comprising affixing the flange and the upright section with respective series of laser welds along each junction of the coplanar outer edge surfaces.

37. The method of claim 31, in combination with a method for aligning the coupling optic in an optical component package along the transmission axis of the tube, comprising:
affixing the mount apparatus in said package to effect said alignment.

38. The combination of claim 37, wherein the mount apparatus is affixed in the package with a series of structural and corrective laser welds along at least one lower edge of the base section of the mount; and wherein the flanged optical assembly has at least one thinned portion with a series of corrective laser welds thereon.

39. The method of claim 31, wherein the flanged optical assembly has at least one thinned portion for facilitating corrective laser welding.

40. The method of claim 31, in combination with a method for aligning the coupling optic in an optical amplifier package, having a channel waveguide chip including a gain medium for amplifying an input signal and producing an output signal, and a pump source, comprising:
affixing the mount apparatus in the package such that the coupling optic therein facilitates coupling of at least one of the input signal, output signal, or pump, to or from the waveguide chip.

41. The combination of claim 40, wherein the channel waveguide chip comprises:
an amplifying core having an input end for receiving the input signal and the pump, and an output end for producing an amplified, output signal; and
a region proximate said input end of said amplifying core in which the input optical signal and the optical pump signal are combined.

42. The combination of claim 41, wherein:
the region comprises a surface through which the pump is received, and wherein the pump and the input signal are together combined into the core at said surface.

43. The combination of claim 42, wherein the surface of the channel waveguide chip is arranged at an approximately 45 degree angle with the core thereof, the pump source transmits the pump at approximately a 90 degree angle with the core, the channel waveguide chip further comprising:
a reflective coating applied over the surface to reflect and thereby combine the pump into the core with the input optical signal.

44. The combination of claim 43, wherein the materials comprising the core and a cladding of the waveguide are structurally and/or chemically distinct having been separately fabricated as physically different materials and brought together during waveguide assembly.

45. The combination of claim 40, wherein the input signal is single mode and the pump is multi-mode, wherein the only optical ports to or from the package are optical signal input and output ports, and wherein the package has at least one planar dimension less than about three inches.
